(19) United States
(12) Patent Application Publication
(10) Pub. No.: US 2011/0062111 A1
(43) Pub. Date: Mar. 17, 2011

(54) METHOD OF FABRICATING MICROSCALE OPTICAL STRUCTURES

(76) Inventors: Jong-Souk Yeo, Corvallis, OR (US); Charlotte R. Lanig, Corvallis, OR (US)

(21) Appl. No.: 12/991,043

(22) PCT Filed: May 6, 2008
(86) PCT No.: PCT/US08/62772

§ 371 Date: Nov. 4, 2010

(51) Int. Cl. C03C 15/02; B24B 13/00; B24B 7/24; B05D 5/06

(52) U.S. Cl. 216/24; 451/41; 451/66; 427/162

(57) ABSTRACT

A method for manufacturing a microscale optical structure from a wafer, including: preparing the wafer with coatings of desired optical properties by depositing the coatings on an optically finished surface of the wafer; mounting the wafer on a supporting base having a releasable medium, with the optically finished surface adjacent the supporting base to protect the optically finished surface; forming additional surfaces of the optical structure at a desired angle and depth using a grinding blade having a cutting face at the angle, the grinding blade being configured to rotate about an axis; and polishing the additional surfaces of the optical structure by introducing a polishing material onto the wafer and using a polishing means to smooth the additional surfaces.

### BACKGROUND

In a wide variety of applications, light or an optical signal can be used to transmit data between an electronic data source and data recipient. In such applications that use light to transmit information, whether over long or short distances, the routing of signals requires the deflection of light from a straight path. Consequently, many optical data transmission applications use waveguides to accomplish this result. Through total internal reflection, a waveguide and direct light along a non-linear path, though bends in waveguides can result in radiative losses.

One of the difficulties of in using optical data transmission is that the fabrication of optical components accurately on a microscale can be very challenging. For example, integrable-sized micro prisms can be used to provide a path to route an optical signal, but the fabrication of integrable micro prisms is difficult and can be costly according to common fabrication techniques.

Micro prisms have generally been fabricated in the prior art by grinding and polishing inclined surfaces of multiple rectangular stacks and rearranging the stacks to repeat these processes until microprism faces are obtained. This typically involves manual handling of the parts in microscale, which adds to the cost and complexity in manufacturing due to the amount of precision required.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a flowchart diagram of a method of fabricating microscale optical structures, according to principles described herein.

FIG. 2 is a diagram of an illustrative embodiment of a grinding blade and a polishing blade mounted on a plurality of rotating spindles, according to principles described herein.

FIG. 3 is a diagram of an illustrative embodiment of a plurality of blades mounted on a plurality of rotating spindles, according to principles described herein.

FIG. 4 is a cross-sectional diagram of an illustrative grinding blade cutting a microscale optical structure, according to principles described herein.

FIG. 5 is a cross-sectional diagram of an illustrative grinding blade cutting a microscale optical structure, according to principles described herein.

FIG. 6 is a cross-sectional diagram of an illustrative grinding blade cutting a microscale optical structure, according to principles described herein.

FIG. 7 is a cross-sectional diagram of an illustrative polishing blade polishing a surface of a microscale optical structure, according to principles described herein.

FIG. 8 is a cross-sectional diagram of an illustrative embodiment of a plurality of blades cutting a microscale optical structure, according to principles described herein.

FIG. 9 is a cross-sectional diagram of an illustrative embodiment of a plurality of blades on two different spindles cutting a microscale optical structure, according to principles described herein.

FIG. 11 is a cross-sectional diagram of an illustrative embodiment of two different spindles, each having two blades, according to principles described herein.

FIG. 12 is a diagram of an illustrative embodiment of a plurality of microscale optical structures fabricated from a wafer, according to principles described herein.

FIG. 13 is a cross-sectional diagram of an illustrative embodiment of two different spindles, each having three blades, according to principles described herein.

FIG. 14 is a diagram of an illustrative embodiment of a plurality of microscale prisms fabricated from a wafer, according to principles described herein.

Throughout the drawings, identical reference numbers designate similar, but not necessarily identical, elements.

### DETAILED DESCRIPTION

The present specification discloses systems and methods related to the fabrication of microscale prisms and other optical structures from a wafer having a substrate of optically conducting material.

A process which does not require the manual handling of many small parts on a microscale is desirable. Such a process would allow for better accuracy in the fabrication process of optical structures and would lessen the likelihood of mechanical failures or inconsistencies. Fabrication of optical structures on and from a single wafer reduces the amount of mechanical processing and manual handling and can take advantage of standard semiconductor fabrication processing techniques for further processing such as metallization, coating, and integration with other devices as desired.

As used in the present specification and in the appended claims, the term “optical computer” refers to a computer or device that uses light instead of electricity to manipulate, store, and/or transmit data. Optical computers may use radiated energy (or photons) having a wavelength generally between 10 nanometers and 500 microns, including, but not limited to, ultraviolet, visible, infrared, and near-infrared light.

As used in the present specification and in the appended claims, the term “optical structure” refers to a device which is optically conductive and may have desired optical properties for manipulating the path of light traveling through the device. Examples of optical structures as thus defined include, but are not limited to, prisms, mirrors, waveguides, and fiber optic lines. These optical structures may be fabricated on a microscale level, such that they may be used as discrete components or in integrated circuits in devices requiring small components for operation, such as modern optical computing technologies. These structures may have measurements as small as several micrometers and as large as more than several millimeters.

The term “optical coating” refers to a thin layer of material deposited on an outer surface of an optical structure that alters the way in which the optical structure reflects and transmits light. Optical coatings allow prisms and other optical structures to be constructed which may not be highly internally reflective by themselves, but are able to internally reflect photons with the presence of the optical coating.

As used in the present specification and in the appended claims, the term “wafer” refers to a thin, generally circular substrate material on which other materials may be grown or deposited, from which optical structures and components may be formed. The structures and components formed on the wafer may be used in integrated circuits. While generally circular, the wafer may take any shape as best suited to a particular application.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

Fabricating multiple optical structures from a single substrate reduces many of the difficulties and costs that result from fabricating such structures from a plurality of rectangular stacks, as is frequently done in the prior art. The fabrication of micro prism sides, grinding, and polishing may all be accomplished with one system, simplifying the overall process. Further, this process is capable of using existing wafer-sawing machines, so there would not need to be an expenditure on new, and potentially very expensive, machinery.

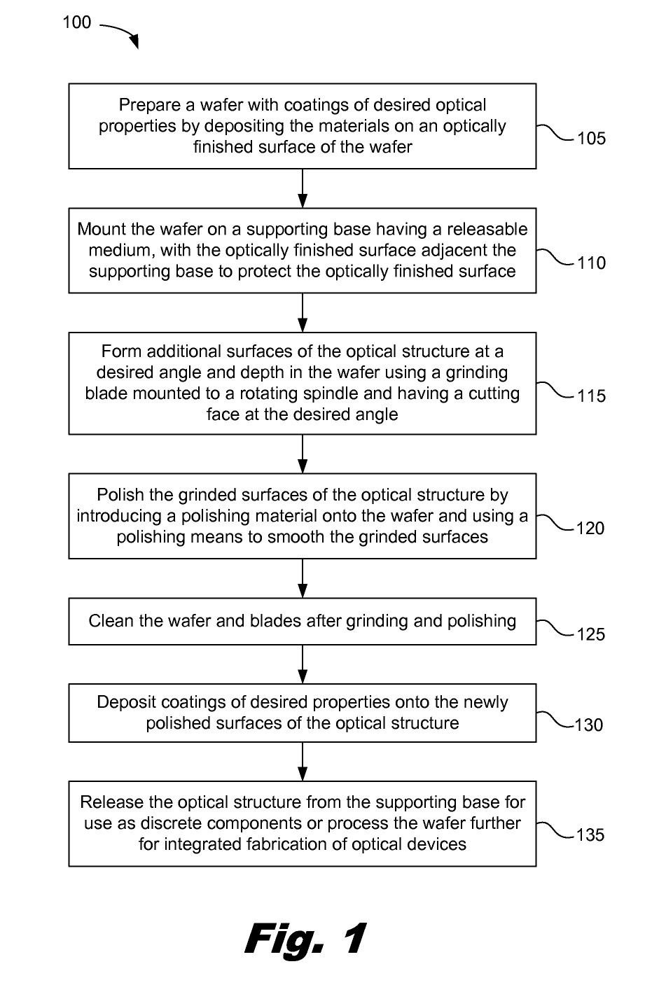

FIG. 1 is an illustrative flowchart diagram (100) of a method for fabricating microscale optical structures from a wafer. The wafer is made from an optically conducting material which is capable of being milled or cut into prisms, waveguides, or other optical structures. The wafer may include silicon, glass, fluorite, quartz, compound semiconductors such as indium phosphide (InP), gallium arsenide (GaAs), or other optically conducting materials, depending on the desired characteristics and functions of the finished optical structures.

The wafer may be prepared (105) before defining the optical structures by optically finishing a surface of the wafer which will not be cut during the process. This may include polishing of the surface. The optically finished surface may serve as one side of a finished optical structure. Coatings of desired optical properties may be deposited on the optically finished surface of the wafer. The coatings may help diminish negative effects the optical structures may have on the clarity or intensity of the light passing through.

Coatings are useful for reducing reflective losses and improving overall optical transmission and are important to achieving clear, bright transmission. The coatings may also help prevent distortions or scattering of the light. Coatings may also be used to prevent undesired phase shifting. As previously mentioned, coatings may also be used in prisms and other optical structures in order to obtain a very high percentage of reflection, particularly in applications where the optical structures themselves are not highly internally reflective.

Simple coatings may be made by depositing thin layers of metals, such as aluminum, silver, or gold, on the optically finished surface. This process is known in the art as silvering. The metal deposited on the surface determines the reflective characteristics of the optical structure. Each material has different reflective properties for certain wavelengths of light, so each one may be more desirable than the others depending on the application in which it is used. Controlling the thickness and density of the coating may allow a decrease in reflectivity while increasing the transmission of the surface. In order to prevent any degradation of reflective property over time, protective or passivative coating such as dense aluminum nitride or silicon oxide can be applied on the silvered surface. Also, a thin adhesive layer that buffers between the metallic coating and substrate can be deposited to improve the adhesion of metallic layer.

Other types of coatings may include dielectric coatings, which include depositing a material or materials with a different refractive index than the substrate onto the substrate. Dielectric coatings may include materials such as magnesium fluoride, calcium fluoride, or metal oxides. A plurality of layers of coatings may be deposited on the surface of the wafer. The surface may have a plurality of metal coatings, or a dielectric coating may be used to enhance the reflectivity or other characteristics of a metal coating. Other configurations of coatings may be used to achieve the desired results.

After preparing the wafer with coatings on the optically finished surface, the wafer may be mounted (110) on a supporting base using a releasable medium. In order to protect the optically finished surface from damage during fabrication of the optical structures, the optically finished surface may be placed adjacent the supporting base. The supporting base provides support for the wafer and allows the wafer to be held in place during fabrication. The supporting base may be wafer tape, saw tape, or other supporting substrate. The cutting of the wafer is extremely precise in order to obtain optical structures in the micrometer range.

The purpose of using a releasable medium is to allow the wafer or individual optical structures to be released from the supporting base once fabrication of the optical structures is completed. The releasable medium may be included in the characteristics of the supporting base, such as with thermal release tape, or it may be an additional material used to temporarily bond the wafer to the supporting base, such as a water soluble adhesive, wax, or other temporary bonding means.

Additional surfaces of the optical structures are formed (115) by cutting a surface of the wafer not adhered to the supporting base. The cuts are made using a grinding blade that is mounted to a rotating spindle. The grinding blade has a cutting face oriented at a desired angle for cutting a surface of the optical structure. The angle at which the cutting face is oriented depends on the physical and optical requirements of each optical structure to be produced, which, in turn, depends on the application in which the optical structures are to be used. The spindle rotates about a central axis at a high speed such that the grinding blade makes a clean cut into the wafer. The blade is properly dressed to achieve the required angle and cut quality.

The additional surfaces are polished (120) by using a polishing device to smooth the additional surfaces after grinding. In one embodiment, the polishing device may be a polishing blade mounted to a rotating spindle. The polishing blade has a smooth face with a polishing medium and is oriented at the desired angle such that it is able to polish the entire area of a newly ground surface. The polishing blade may be mounted on the same spindle as the grinding blade, or it may be mounted on a different spindle. A polishing material may be introduced onto the surface of the wafer in order to aid the polishing process.

In an alternative embodiment, the polishing device may be a polishing etch. For example, wafer level etching on a wafer of glass or silicon that has been processed to produce optical structures may result in a sufficiently smooth surface and adequate optical finish. A polishing etch in this example may include a slight etching process that heals or smoothes damaged surfaces without incurring significant changes in the shape or dimension of the optical structures previously formed. The wafers are generally etched in a short time in order to remove a few microns or less from the surface. In the case of glass, thermal reflow may be used to smooth the surface. For silicon, various solutions of hydrofluoric (HF), nitric (HNO₃), and/or acetic acids may be employed at room temperature. Tetramethylammonium hydroxide (TMAH) may be used to etch silicon at a slightly elevated temperature. In embodiments including optical structures such as hollow core waveguides, improved edge and average surface roughness may be obtained by using a mixture of HF, HNO3, and acetic chemistries with some amount of dilution to clean off the surface and any edges on the optical structures.

After grinding and polishing the surfaces of the optical structures on the surface of the wafer, the wafer is cleaned (125) in preparation for additional deposits or further fabrication steps. The spindles and blades may also be cleaned for later use.

Optical coatings may then be deposited (130) on the newly polished surfaces such that all of the surfaces of the optical structures are polished and coated. The optical structures may be released (135) from the supporting base such that the individual optical structures may be used as discrete components. The wafer may also be left on the supporting base and further fabricated for use as a package of integrated components in an optical system. The process may include additional steps of grinding and polishing before removing the wafer from the supporting base in order to obtain high quality, precise optical structures.

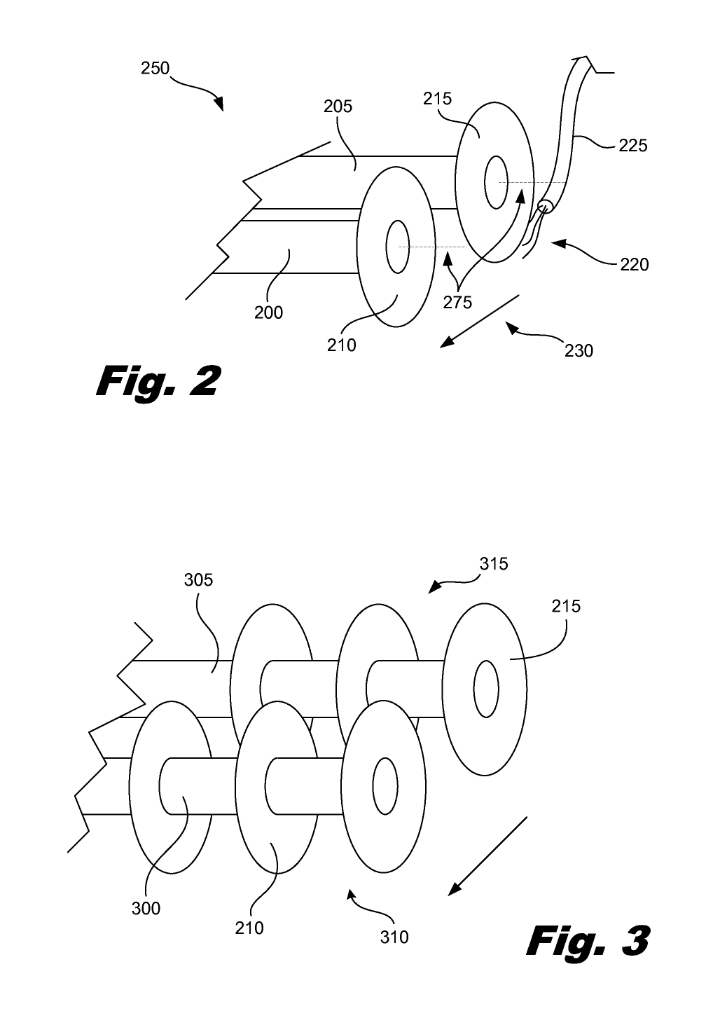

FIG. 2 shows an apparatus (250) including first and second spindles (200, 205) having a grinding blade (210) and a polishing blade (215). In the current embodiment, the first spindle (200) and grinding blade (210) are positioned forward of the second spindle (205) and polishing blade (215) such that an unfinished surface of a wafer is ground before it is polished, moving in the direction of the arrow (230). The spindles (200, 205) and blades (210, 215) may rotate about an axis (275).

A polishing material (220) may be introduced onto the wafer through a conduit (225) attached to a pump. The conduit (225) in this embodiment is positioned rearward of the polishing blade (215), but the conduit (225) may be placed in any position in which the polishing material (220) may be introduced onto the wafer. The polishing material (220) may also be introduced onto the wafer by other means.

The second spindle (205) on which the polishing blade (215) is mounted may rotate substantially slower than the first spindle (200) on which the grinding blade (210) is mounted. A slower speed than what is necessary for clean, accurate grinding may be ideal for polishing. The spindles (200, 205) and blades (210, 215) are accurately aligned in order to fabricate adequate optical structures on such a small scale. The spindles (200, 205) may also be translatable such that the blades (210, 215) are able to be repositioned, lifted, or otherwise translated in real time.

FIG. 3 shows first and second spindles (300, 305), each having a plurality of blades (310, 315). The first spindle (300) may include a plurality of grinding blades, while the second spindle (305) may include a plurality of polishing blades. In such a configuration, the grinding blades (210) on the first spindle (300) may make multiple cuts into the wafer simultaneously and then the polishing blades (215) on the second spindle (305) may polish those same cuts as the second spindle (305) passes over the cuts. Each spindle (300, 305) may alternatively have a combination of both grinding and polishing blades, depending on the desired operation of the spindles and blades.

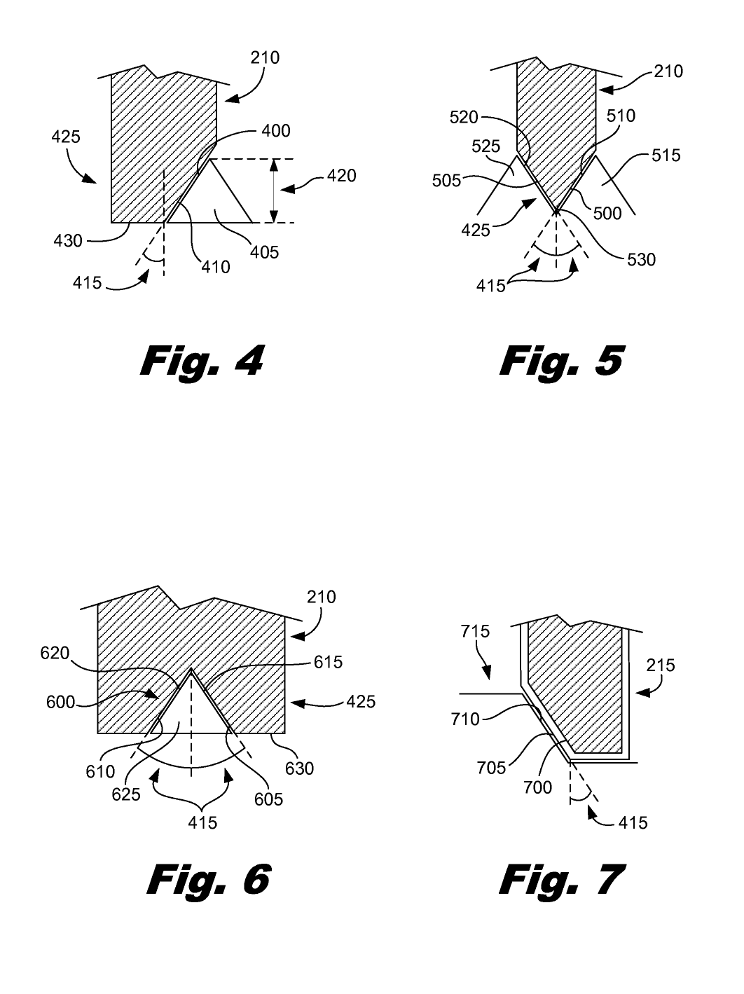

FIG. 4 shows a cross-section of an illustrative grinding blade (210) cutting a first surface (400) of a microscale prism (405). The grinding blade (210) has a cutting face (410) which is oriented at a desired angle (415) for defining the first surface (400) of the prism (405). The grinding blade (210) is also positioned and shaped such that the blade (210) cuts at a certain depth (420). For applications where individual prisms or optical structures are fabricated, the grinding blade (210) may be positioned so that it cuts all the way through the wafer to the supporting base beneath the wafer. An end (425) of the blade (210) may also include a flat portion (430) which will aid the separation of the individual optical structures from one another. Thus, the individual optical structures may be separated from one another and used as discrete components or spaced farther apart in integrated circuits. The grinding blade (210) may have a hard facing or be made of a hard material in order to reduce wear on the blade (210) and make continuously precise cuts. The hard material or hard facing may include a metal matrix material, carbide, tungsten, diamond, cubic boron nitride, hardened steel, any combination thereof, or any combination of wear-resistant materials with a hardness suitable for grinding the wafer while experiencing minimal wear to the blade.

In one embodiment of the grinding blade (210) of FIG. 4, the width of the flat portion (430) may vary, depending on the depth (420) of the cut and the wear of the blade (210). In such an embodiment, each optical structure (405) would be spaced at least as far apart as the width of the flat portion (430) of the blade (210).

FIG. 5 shows a cross-section of a grinding blade (210) having two cutting faces (500, 505), or a bevel cut. A first cutting face (500) is oriented at the desired angle (415) for defining a first surface (510) of a first optical structure (515), and a second cutting face (505) is oriented at the desired angle (425) for defining a second surface (520) of a second optical structure (525). This may allow a single grinding blade (210) to define surfaces for a plurality of optical structures, which may be particularly useful for applications involving integrated optical structures positioned adjacent one another. It may also allow the grinding blade (210) to be more efficient, as it would be grinding two surfaces (510, 520) at once.

The end (425) of the blade (210) may include a pointed portion (530). This may allow for closer spacing of optical structures, which may be useful in integrated optical circuit applications where it is desirable to save space on the integrated chip. While the angles of the cutting faces (500, 505) are shown to be equal in this embodiment, each cutting face may be oriented at a different angle or have multiple facets at different angles, depending on the desired optical structure to be produced.

FIG. 6 shows a cross-section of a grinding blade (210) having an inset portion (600). The inset portion (600) may be a dimple or other recess at the end (425) of the blade (210). The inset portion (600) has first and second cutting faces (605, 610), each at the desired angle (415) for defining first and second surfaces (615, 620) of a single optical structure (625). The end (425) may also have flat portions (630) surrounding the inset portion (600), which may both provide strength for the blade (210) around the inset portion (600) and separation between individual, adjacent optical structures. It may also be useful for creating each microscale prism with a single pass of a grinding blade, rather than making one pass for each surface. A polishing blade having the same shape as the grinding blade may make a pass over the optical structure to polish the optical structure after grinding.

FIG. 7 shows a cross-section of a polishing blade (215) having a smooth face (700) and a polishing medium (705). The surface (710) of the optical structure (715) is polished in order to remove any physical aberrations which may affect how light is transmitted through the optical structure (715). The smooth face (700) and polishing medium (705) are oriented at the desired angle (415) at which the surface (710) was ground. The polishing medium (705) may be a pad or other material attached to the smooth face (700). Alternatively, the polishing blade (215) itself may be made of a soft material such that the smooth face (700) is the polishing medium (705).

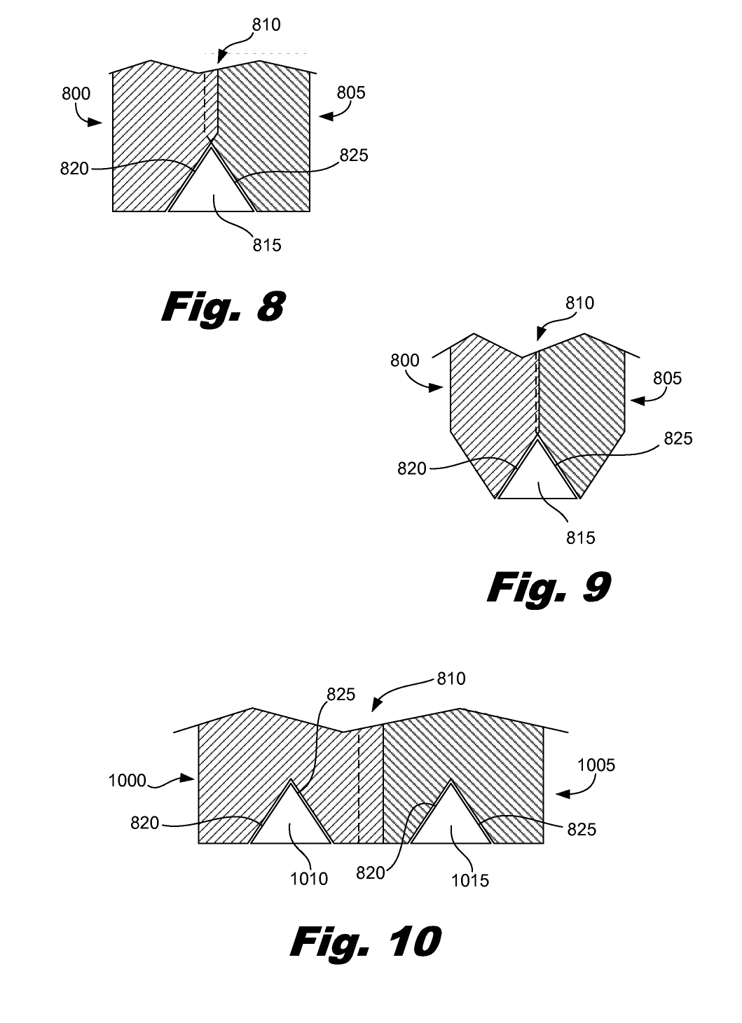

FIGS. 8 through 10 illustrate embodiments of a plurality of blades on separate spindles similar to the blades shown in the embodiments of FIGS. 4 through 6, respectively. FIG. 8 shows first and second blades (800, 805) oriented in opposite directions. The blades may be symmetrical, as shown in the embodiments of FIGS. 9 and 10, and may be mounted on the spindles in either direction. The first blade (800) is mounted on a first spindle positioned forward the second blade (805), which is mounted on a second spindle. The blades may be two grinding blades, two polishing blades, or a grinding blade and a polishing blade. The blades may be aligned so that there is a slight overlap (810) between the first and second blades (800, 805).

In an embodiment where both blades are grinding blades, the first blade (800) may grind at least a first surface (820) of an optical structure (815), and the second blade (805) may follow, grinding at least a second surface (825) of the optical structure (815). In an embodiment where both blades are polishing blades, the first blade (800) may polish the first surface (820) that has already been ground and the second blade (805) may follow, polishing the second surface (825) which has also already been ground. In an embodiment wherein the first blade (800) is a grinding blade and the second blade (805) is a polishing blade, the grinding blade grinds the second surface (825) first and then grinds the first surface (820). The polishing blade follows, first polishing the second surface (825) and then polishing the first surface (820). The spindles may be translated accordingly to allow the polishing blade to polish a surface which has already been ground.

In the embodiment of FIG. 10, each blade (1000, 1005) may grind or polish both the first and second surfaces (820, 825) of individual optical structures (1010, 1015) with a single pass over the wafer. This may allow for a faster fabrication process, though it may also lower the amount of optical structures that may be placed on the wafer, due to the extra space ground by the flat portions (630) on the end (425) of each blade (1000, 1005).

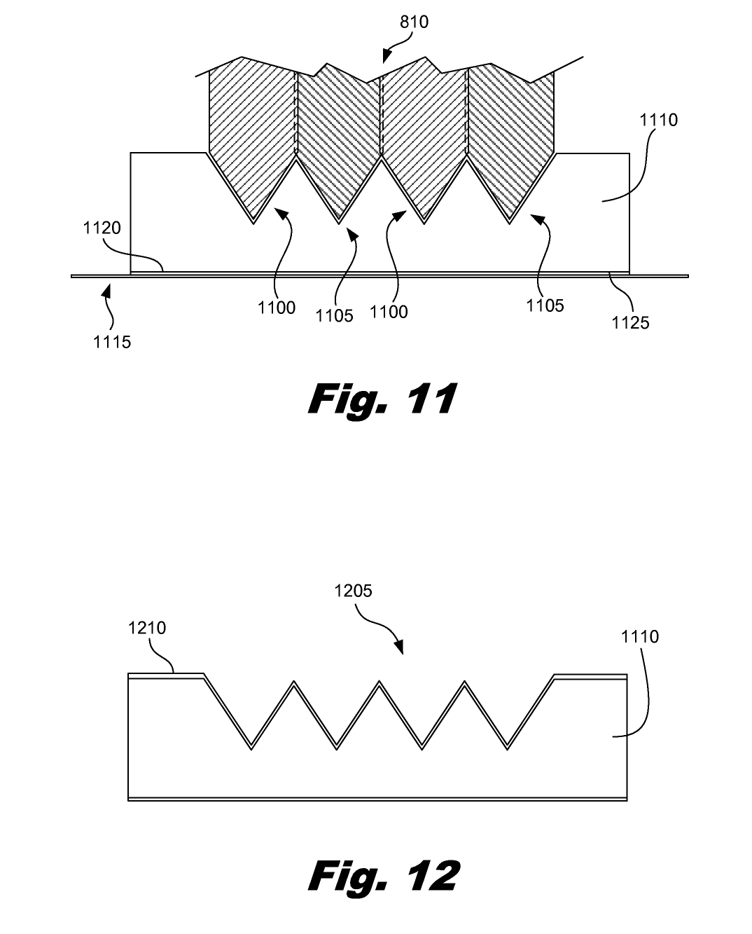

FIG. 11 shows an illustrative embodiment of an apparatus using first and second sets of blades (1100, 1105), each set of blades being on a different spindle and having two blades. As previously mentioned, each spindle may have a plurality of all grinding blades, a plurality of all polishing blades, or a combination of both grinding and polishing blades, depending on the requirements of the desired application. The blades may be spaced such that there is a slight overlap (810) between each of the blades as they pass over the wafer (1110), though there may be any amount of spacing between each blade or set of blades. For example, each blade may be spaced far enough apart to allow greater distance between each of the optical structures on the wafer (1110) than is shown in the current embodiment. This can be achieved by placing a spacer of desired thickness between the blades in the gang blade type of spindle. FIG. 11 also illustrates a supporting base (1115) on which the wafer (1110) may be mounted, and an optical coating (1120) that was deposited on an optically finished surface (1125) of the wafer (1110) before mounting the wafer (1110).

The embodiment of FIG. 12 illustrates a wafer (1110) on which a plurality of optical structures (1205) have been formed. After grinding and polishing the wafer, additional materials (1210) may be deposited on the wafer (1110), such as optical coatings for the newly polished optical structures. The wafer (1110) may be processed further for use in integrated applications. Lithography processes may be used to integrate electrical circuitry with optical circuitry. Wafers that have optical coatings on both sides of the wafer may allow for complete or nearly complete internal reflection. This may be useful in applications using optical structures such as fiber optic lines or other integrated optical structures.

In various embodiments of the system described herein, the apparatus may include as many spindles as desired. Additionally, each spindle may have as many blades as desired.

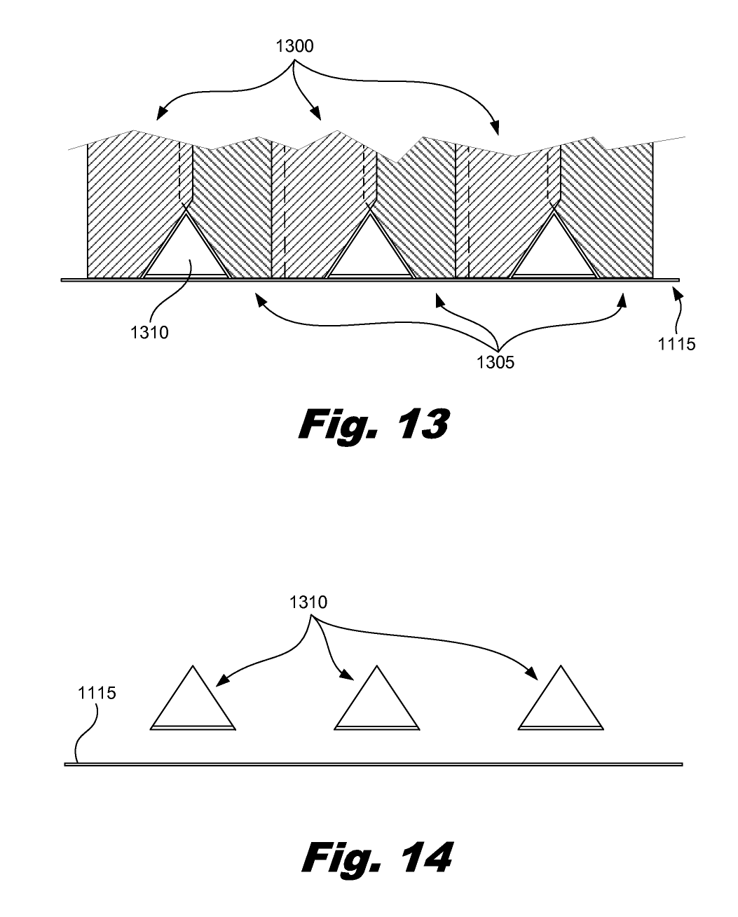

FIG. 13 shows an illustrative embodiment of an apparatus using two sets of three blades (1300, 1305), each set of blades being on a separate spindle, such that individual and separate micro prisms (1310) are formed. The supporting base (1115) and releasable medium hold each prism (1310) in place while the blades grind and polish in order to produce clean cut and evenly polished surfaces.

After polishing, the individual prisms (1310) may be released from the supporting base (1115) and used as discrete components, either in the same application or in different applications. This is facilitated where the wafer is mounted on the supporting base (1115) using a releasable medium, as illustrated in FIG. 14. In the embodiment of FIG. 14, no additional layers of optical coatings are deposited onto the prisms (1310), such that the prisms (1310) may be used as reflective prisms in any optical application.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method for manufacturing a microscale optical structure from a wafer, comprising:
preparing said wafer with coatings of desired optical properties by depositing said coatings on an optically finished surface of said wafer;
mounting said wafer on a supporting base having a releasable medium, with said optically finished surface adjacent said supporting base to protect said optically finished surface;
forming additional surfaces of said optical structure at a desired angle and depth in said wafer using a grinding blade having a cutting face at said angle, said grinding blade being configured to rotate about an axis; and
polishing said additional surfaces of said optical structure by introducing a polishing material onto said wafer and using a polishing means to smooth said additional surfaces.

2. The method of claim 1, wherein said polishing means is a polishing blade having a smooth face comprising a polishing medium at said angle, said polishing blade being configured to rotate about an axis.

3. The method of claim 2, wherein said grinding blade and said polishing blade are mounted on a single rotatable spindle.

4. The method of claim 2, wherein said grinding blade and said polishing blade are mounted on different rotatable spindles.

5. The method of claim 4, wherein said spindles comprise a plurality of blades.

6. The method of claim 1, wherein said optical structure is a prism.

7. The method of claim 1, wherein said polishing means is a polishing etch.

8. The method of claim 1, further comprising the steps of cleaning said additional surfaces and depositing optical coatings comprising desired properties on said additional surfaces of said optical structure.

9. The method of claim 1, wherein said grinding blade comprises two cutting faces at said angle.

10. The method of claim 1, wherein said grinding blade comprises an inset portion having two cutting faces at said angle.

11. The method of claim 1, wherein an end of said grinding blade comprises a flat portion.

12. The method of claim 1, wherein said releasable medium comprises a water soluble adhesive, and further comprising the step of releasing said optical structure from said supporting substrate for use as a discrete component.

13. The method of claim 1, wherein said releasable medium comprises a thermal release adhesive, and further comprising the step of releasing said optical structure from said supporting substrate for use as a discrete component.

14. A method for manufacturing a microscale optical structure from a substrate, comprising:
mounting said substrate on a supporting base having a releasable medium;
cutting an unpolished surface of said optical structure at a desired angle and depth in said wafer using a cutting means oriented at said angle, said cutting means being configured to rotate about an axis; and
polishing said unpolished surface of said optical structure by introducing a polishing material onto said wafer and using a polishing means to smooth said unpolished surface.

15. An apparatus for fabricating microscale optical structures from a wafer, comprising:
at least one blade mounted to at least one rotating spindle;
said at least one blade being a grinding blade having an angled cutting face for cutting a surface of a microscale optical structure at an angle; and
a polishing means for polishing said optical structure at said angle;
wherein said at least one blade is configured to cut a surface of a substrate at said angle for fabricating microscale optical structures.
